(19) United States
(12) Patent Application Publication
(10) Pub. No.: US 2015/0055662 A1
(43) Pub. Date: Feb. 26, 2015

(54) INTERNET GROUP MANAGEMENT PROTOCOL (IGMP) LEAVE MESSAGE PROCESSING SYNCHRONIZATION

(71) Applicant: International Business Machines Corporation, Armonk, NY (US)

(72) Inventors: Chidambaram Bhagavathiperumal, Santa Clara, CA (US); Gangadhar Hariharan, Santa Clara, CA (US); Naveen C. Sekhara, Milpitas, CA (US); Raluca Voicu, Bucharest (RO)

(73) Assignee: International Business Machines Corporation, Armonk, NY (US)

(21) Appl. No.: 13/971,616

(22) Filed: Aug. 20, 2013

(51) Int. Cl. H04L 7/00; H04L 12/931

(52) U.S. Cl. CPC H04L 7/0004; H04L 49/70
USPC 370/503

(57) ABSTRACT

Embodiments relate to synchronizing Internet Group Management Protocol (IGMP) leave processing in a system. One embodiment includes a system with a first access switch, a first virtual switch having a first timer, and a second virtual switch having a second timer. The first virtual switch and the second virtual switch are connected with the first access switch. The first access switch transmits an IGMP leave message to the first virtual switch. The first virtual switch transmits a synchronization message to the second virtual switch. The second virtual switch updates the second timer based on receiving the synchronization message.

### BACKGROUND

The present invention relates to network switches and switching, and more particularly, this invention relates to providing Internet Group Management Protocol (IGMP) leave message processing synchronization in a virtual link aggregation group (vLAG) environment.

In a data center, each access switch is typically connected to two aggregation switches for redundancy. VLAG is a feature that uses all available bandwidth without sacrificing redundancy and connectivity. Link aggregation is extended by vLAG across the switch boundary at the aggregation layer. Therefore, an access switch has all uplinks in a LAG, while the aggregation switches cooperate with each other to maintain the vLAGs. Since vLAG is an extension to standard link aggregation, layer 2 and layer 3 features may be supported on top of vLAG.

### BRIEF SUMMARY

Embodiments relate to synchronizing Internet Group Management Protocol (IGMP) leave processing in a system. One embodiment includes a system with a first access switch, a first virtual switch having a first timer, and a second virtual switch having a second timer. The first virtual switch and the second virtual switch are connected with the first access switch. The first access switch transmits an IGMP leave message to the first virtual switch. The first virtual switch transmits a synchronization message to the second virtual switch. The second virtual switch updates the second timer based on receiving the synchronization message.

Another embodiment comprises a computer program product for synchronization of IGMP leave message processing. The computer program product comprising a computer readable storage medium having program code embodied therewith. The program code readable/executable by a processor to perform a method comprising transmitting, by a first access switch, an IGMP leave message to by a first virtual switch having a first timer. The first virtual switch transmits a synchronization message to a second virtual switch. The second virtual switch updates a second timer based on receiving the synchronization message, synchronizing the first timer and the second timer.

One embodiment comprises a method that includes receiving an IGMP leave message by a first switch having a first timer. The first switch transmits a synchronization message to a second switch. The second switch updates a second timer based on receiving the synchronization message. The first timer and the second timer are synchronized.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 is a network architecture, in accordance with one embodiment of the invention;

FIG. 2 shows a representative hardware environment that may be associated with the servers and/or clients of FIG. 1, in accordance with one embodiment of the invention;

FIG. 3 is a diagram of an example data center system, in accordance with one embodiment of the invention;

FIG. 4 is a block diagram of a system, according to one embodiment of the invention; and

FIG. 5 is a block diagram showing a process for leave message processing synchronization, in accordance with an embodiment of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as “logic,” a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium include the following: a portable computer diskette, a hard disk, a random access memory (RAM), a read-only memory (ROM), an erasable programmable read-only memory (EPROM or Flash memory), a portable compact disc read-only memory (CD-ROM), a Blu-ray disc read-only memory (BD-ROM), an optical storage device, a magnetic storage device, or any suitable combination of the foregoing. In the context of this document, a non-transitory computer readable storage medium may be any tangible medium that is capable of containing, or storing a program or application for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer readable storage medium and that can communicate, propagate, or transport a program for use by or in connection with an instruction execution system, apparatus, or device, such as an electrical connection having one or more wires, an optical fibre, etc.

Program code embodied on a computer readable medium may be transmitted using any appropriate medium, including but not limited to wireless, wireline, optical fibre cable, RF, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer or server may be connected to the user's computer through any type of network, including a local area network (LAN), storage area network (SAN), and/or a wide area network (WAN), or the connection may be made to an external computer, for example through the Internet using an Internet Service Provider (ISP).

Aspects of the present invention are described herein with reference to flowchart illustrations and/or block diagrams of methods, apparatuses (systems), and computer program products according to various embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

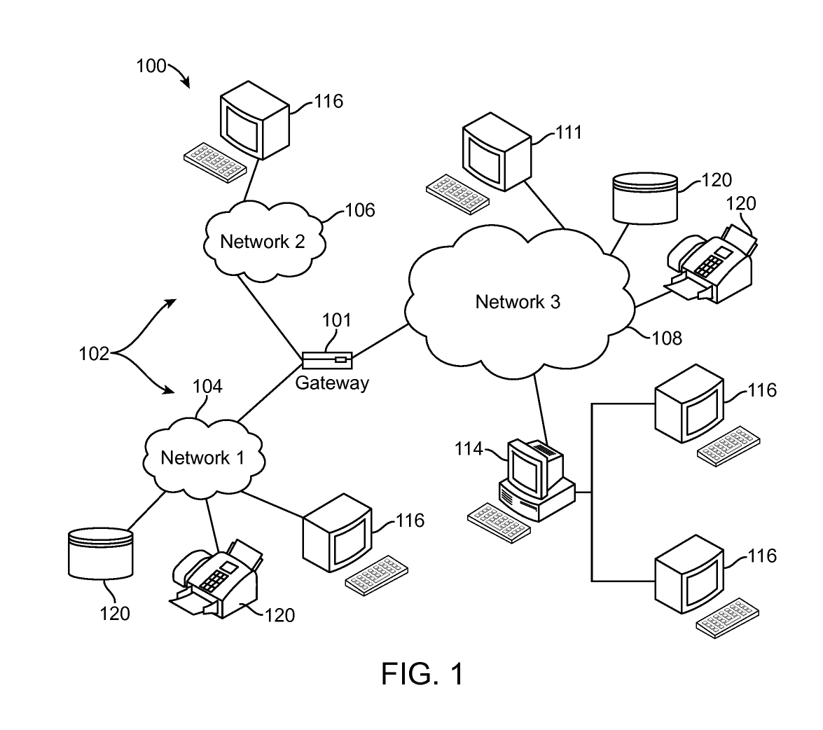

Referring now to the drawings, FIG. 1 illustrates a network architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, handheld computer, printer, and/or any other type of logic-containing device. It should be noted that a user device 111 may also be directly coupled to any of the networks, in some embodiments.

A peripheral 120 or series of peripherals 120, e.g., facsimile machines, printers, scanners, hard disk drives, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In other examples, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, therefore allowing access and distribution of services across many computing systems. Cloud computing typically involves an Internet connection between the systems operating in the cloud, but other techniques of connecting the systems may also be used, as known in the art.

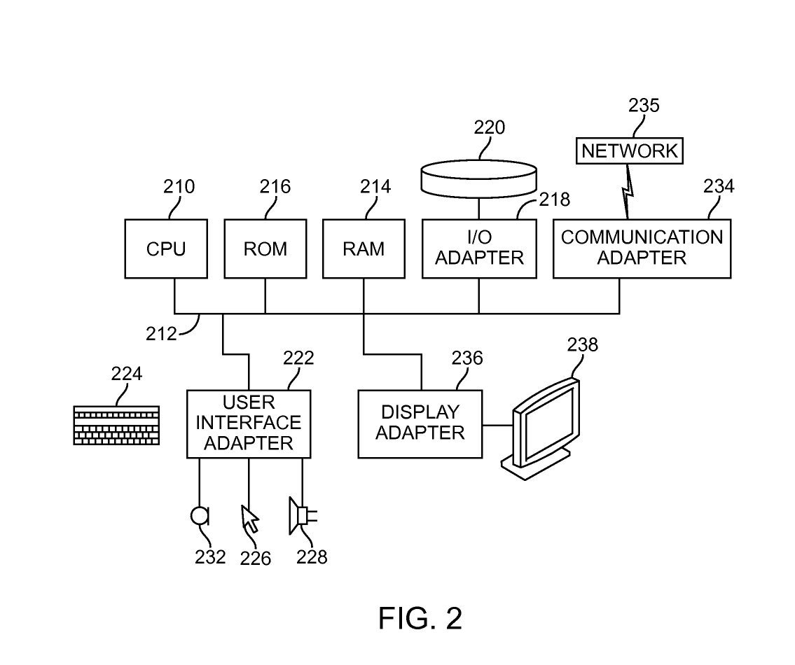

FIG. 2 shows a representative hardware environment associated with a user device 116 and/or server 114 of FIG. 1, in accordance with one embodiment. In one example, a hardware configuration includes a workstation having a central processing unit 210, such as a microprocessor, and a number of other units interconnected via a system bus 212. The workstation shown in FIG. 2 may include a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen, a digital camera (not shown), etc., to the bus 212, communication adapter 234 for connecting the workstation to a communication network 235 (e.g., a data processing network) and a display adapter 236 for connecting the bus 212 to a display device 238.

In one example, the workstation may have resident thereon an operating system such as the MICROSOFT WINDOWS Operating System (OS), a MAC OS, a UNIX OS, etc. It will be appreciated that other examples may also be implemented on platforms and operating systems other than those mentioned. Such other examples may include operating systems written using JAVA, XML, C, and/or C++ language, or other programming languages, along with an object oriented programming methodology. Object oriented programming (OOP), which has become increasingly used to develop complex applications, may also be used.

According to one or more embodiments, synchronizing IGMP leave processing occurs in a system. One embodiment includes a system with a first access switch, a first virtual switch having a first timer, and a second virtual switch having a second timer. The first virtual switch and the second virtual switch are connected with the first access switch. The first access switch transmits an IGMP leave message to the first virtual switch. The first virtual switch transmits a synchronization message to the second virtual switch. The second virtual switch updates the second timer based on receiving the synchronization message.

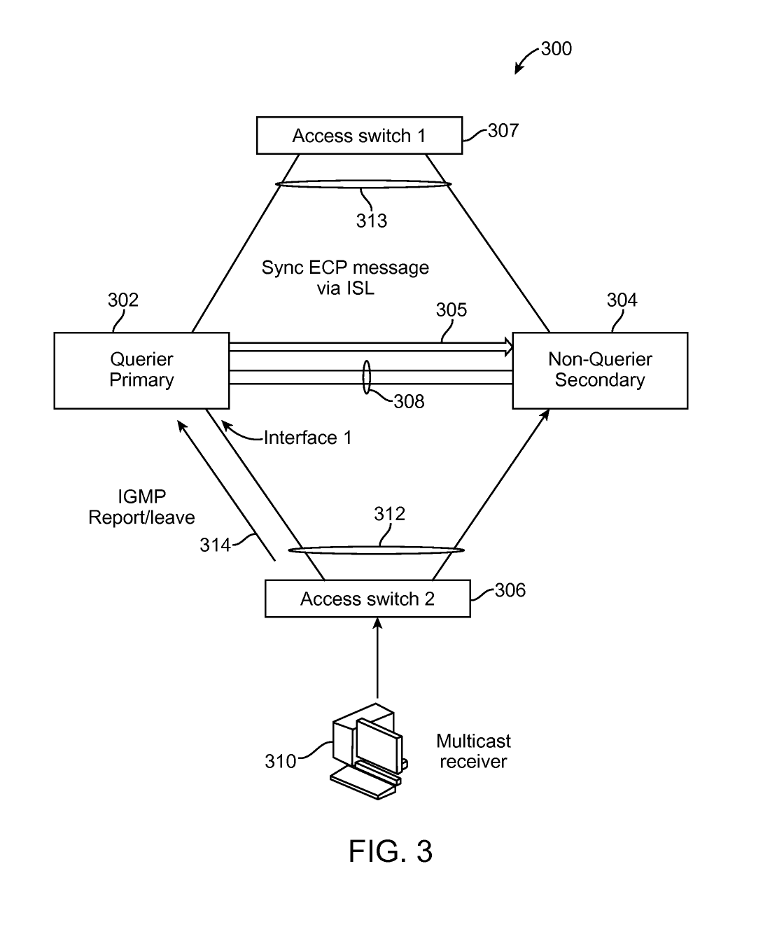

FIG. 3 shows a diagram of an example data center system 300 for use of one embodiment. In one embodiment, each access switch 306/307 is connected to two aggregation switches for redundancy, for example, primary virtual link aggregation group (vLAG) switch 302 and secondary vLAG switch 304. Link aggregation is extended by vLAG across the switch boundary at the aggregation layer. Therefore, an access switch 306/307 has all uplinks in a LAG 312/LAG 313, while the vLAG switches 302 and 304 cooperate with each other to maintain the vLAGs. In one embodiment, the inter-switch link (ISL) 308 is used for communications between the primary vLAG switch 302 and secondary vLAG switch 304. It should be noted that the vLAG ISL uses Edge Control Protocol (ECP) for its transport mechanism.

In one embodiment, both primary vLAG switch 302 and secondary vLAG switch 304 have IGMP snooping enabled. When the Internet Protocol (IP) multicast receiver 310 connected to the access switch 306 sends an IGMP report in a packet, the packet is forwarded to only one of the vLAG switches (either primary 302 or secondary 304) and an IP multicast group entry will be created in the switch the packet is sent to. In one embodiment, the multicast receiver 310 sends IGMP reports/leaves 314 towards the vLAG switches 302 and 304. Since both of the vLAG switches 302 and 304 have IGMP snooping enabled, it allows them to learn the IGMP groups for which IGMP reports/leaves are sent. In one embodiment, when multicast receiver 310 sends an IGMP report, the report will arrive at the switch 306 (e.g., access switch 2) and then a hash function is performed on the IGMP report to hash the IGMP report to the vLAG switch 302 (primary vLAG switch).

In one example, consider that the IGMP group is learned on both vLAG switch 302 and vLAG switch 304. As per RFC 2236, Internet Group Management Protocol, Version 2, November 1997 [IGMPv2], when a Querier receives an IGMP leave group message for the vLAG, it sends a group specific query (GSQ) on the vLAG switch interface where it received the leave message. The responsibility of the Querier is to send out IGMP group membership queries on a timed interval, to retrieve IGMP membership reports from active members, and to allow updating of the group membership tables. A Layer 2 switch supporting IGMP Snooping can passively snoop on IGMP Query, Report, and Leave (IGMPv2) packets transferred between IP Multicast routers/switches and IP Multicast hosts to determine the IP Multicast group membership. IGMP snooping checks IGMP packets passing through the network, picks out the group registration, and configures Multicasting accordingly.

In a typical vLAG setup, if the Querier receives an IGMP leave message, it would send the GSQ on the interface (Interface 1) where it received the leave message. This would set the group timer on the Querier vLAG switch to the query interval. The timer for the same group on the vLAG peer switch, which is a Non-Querier, will not receive any indication that the group timer on the querier has been set to the query interval. The timer of the non-querier vLAG switch remains the same, which leads to inconsistency in a vLAG setup.

In one example, consider that IGMP fast leave is enabled on both vLAG switches 302 and 304. According to IGMPv2, if no more than one host is attached to each VLAN switch port, then the fast leave feature may be configured. The fast leave feature does not send last member query messages to hosts. As soon as the software receives an IGMP leave message, the software stops forwarding multicast data to that port. The software ignores the configuration of the last member query interval when you enable the fast leave feature because it does not check for remaining hosts. With IGMP fast leave, the Querier sets its timer equal to 1 second on the Querier. Fast leave also means that the Querier will not send the GSQ on the interface on which it received the leave message.

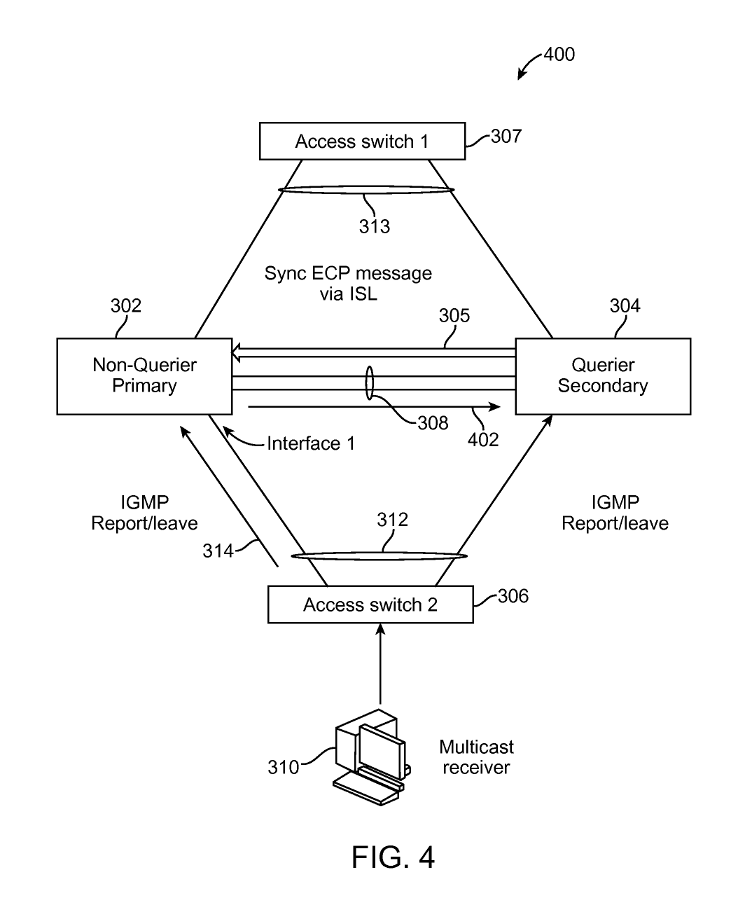

FIG. 4 shows a system 400 according to one embodiment. In one example, consider that the primary switch, vLAG switch 302, is the Non-Querier and the secondary switch, vLAG 304, is the Querier. Consider IGMP fast leave feature is on both vLAG switches. In the vLAG setup of system 400, when the Non-Querier (vLAG switch 302) receives an IGMP leave message (e.g., from access switch 306), it will forward the leave message 402 to the peer Querier, vLAG switch 304. The Querier, vLAG switch 304, because it has the fast leave feature enabled, will set its timer to 1 second. However, in the typical vLAG system, the vLAG switch 304 (acting as Querier) will not send a GSQ back. Therefore, the Non-Querier, vLAG switch 302, will not receive a GSQ and there is no change in its timer, which leads to inconsistency in a vLAG setup.

In the examples provided above, in the typical vLAG system, the vLAG switches do not have the same timer value in their respective timers. With vLAG technology, both the vLAG switches should have the same groups and timers on both of the peer switches (vLAG 302 and vLAG 304). In one embodiment, the vLAG switch that is the Querier amongst the two vLAG switches sends an ECP synchronization message 305 over the ISL 308 to the peer, notifying the peer to update its IGMP group timer.

In system 300 (FIG. 3), when the Querier (vLAG switch 302) receives the IGMP leave message, it sends a GSQ back through interface 1. The Querier (vLAG switch 302) also sends a vLAG-ECP sync message 305 over the ISL 308 to the peer (vLAG switch 304). In one embodiment, the vLAG-ECP sync message 305 is sent with type: IGMP_VLAG_MEMBERSHIP_LEAVE_SYNC. In one embodiment, the vLAG-ECP sync message 305 contains: a virtual local area network (vLAN) identification (ID), the trunk ID which houses the interface, and the IGMP group address. In one embodiment, when the peer receives the vLAG-ECP sync message 305, it updates its timer to the query interval. In one embodiment, both of the switches (vLAG switch 302 and vLAG switch 304) behave as if both received the IGMP leave message themselves, and both also have a consistent timer value for the respective timers.

In system 400, both vLAG switches 302 and 304 have fast leave enabled. In one embodiment, when the Non-Querier (vLAG switch 302) receives an IGMP leave message, it forwards the leave message to the Querier (vLAG switch 304) as per IGMP protocol. In a typical vLAG system (using system 400 components for discussion), the Querier (vLAG switch 304) updates its group timer to 1 second and does not send a GSQ back to the Non-Querier (vLAG switch 302). In one embodiment, in system 400 the Querier (vLAG switch 304) sends a vLAG-ECP sync message 305 over the ISL 308 to the peer. This message is sent with type: IGMP_VLAG_MEMBERSHIP_LEAVE_SYNC. In one embodiment, the vLAG-ECP sync message 305 contains: vLAN ID, trunk ID which houses the interface, and IGMP group address. The Non-Querier (vLAG switch 302) receives the vLAG-ECP sync message 305 and updates its timer to 1 second. This way both the vLAG switches 302 and 304 behave as if both received the IGMP leave message and both will have a consistent timer value.

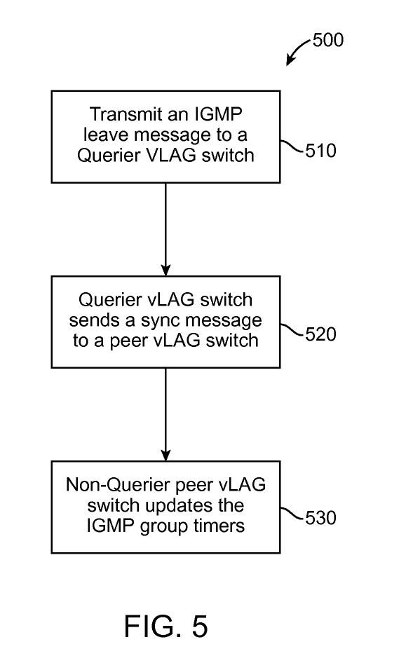

FIG. 5 shows a block diagram of a process 500 for IGMP leave message processing synchronization, according to one embodiment. Process 500 may be performed in accordance with any of the environments depicted in FIGS. 1-4, among others, in various embodiments. Each of the blocks 510-530 of process 500 may be performed by any suitable component of the operating environment. In one example, process 500 may be partially or entirely performed by a vLAG switch, an IGMP module, etc.

As shown in FIG. 5, in process block 510, an IGMP leave message is transmitted to a Querier vLAG switch. In one embodiment, the IGMP leave message may be transmitted from an access switch to a vLAG switch, or from a vLAG switch to a peer vLAG switch. In one embodiment, the leave message may be initiated from a multicast receiver (e.g., multicast receiver 310, FIGS. 3 and 4). In one embodiment, the transmitted IGMP leave message is received by a first switch, such as vLAG switch 302 (FIG. 3), or vLAG switches 302 and 304 in FIG. 4.

In one embodiment, in process block 520 the Querier vLAG switch sends a sync message (e.g., vLAG-ECP sync message 305, FIGS. 3 and 4) to a peer vLAG switch. In one embodiment, in process block 530 the non-Querier peer switch updates its IGMP group timer based on the vLAG-ECP sync message 305, which synchronizes the timers of the two vLAG peer switches.

According to various embodiments, the process 500 may be performed by a system, computer, or some other device capable of executing commands, logic, etc., as would be understood by one of skill in the art upon reading the present descriptions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be emphasized that the above-described embodiments of the present invention, particularly, any “preferred” embodiments, are merely possible examples of implementations, merely set forth for a clear understanding of the principles of the invention.

Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system, comprising:
a first access switch;
a first virtual switch having a first timer; and
a second virtual switch having a second timer, the first virtual switch and the second virtual switch are coupled with the first access switch, wherein the first access switch transmits an Internet Group Management Protocol (IGMP) leave message to the first virtual switch, the first virtual switch transmits a synchronization message to the second virtual switch, wherein the second virtual switch updates the second timer based on receiving the synchronization message.

2. The system of claim 1, further comprising a multi-cast receiver coupled to the first access switch, wherein the multi-cast receiver transmits the IGMP leave message to the first access switch.

3. The system of claim 2, wherein the first virtual switch is enabled as an IGMP querier.

4. The system of claim 3, wherein the synchronization message is transmitted over an inter-switch link (ISL) between the first virtual switch and the second virtual switch.

5. The system of claim 4, wherein the ISL uses an edge control protocol (ECP) transport mechanism.

6. The system of claim 4, wherein information comprises an IGMP group address, a virtual local area network (vLAN) identification and a trunk identification for the IGMP querier.

7. The system of claim 6, wherein the first virtual switch and the second virtual switch form a first virtual link aggregation group (vLAG) with the first access switch and form a second vLAG with a second access switch.

8. A computer program product for synchronization of Internet Group Management Protocol (IGMP) leave message processing, the computer program product comprising a computer readable storage medium having program code embodied therewith, the program code readable/executable by a processor to perform a method comprising:
transmitting, by a first access switch, an IGMP leave message to a first virtual switch having a first timer;
transmitting, by the first virtual switch, a synchronization message to a second virtual switch; and
updating, by the second virtual switch, a second timer based on receiving the synchronization message for synchronizing the first timer and the second timer.

9. The program of claim 8, wherein the first virtual switch is enabled as an IGMP querier.

10. The program of claim 9, wherein the IGMP leave message is transmitted to the first access switch from a multicast receiver.

11. The program of claim 10, wherein the synchronization message is transmitted over an inter-switch link (ISL).

12. The program of claim 11, wherein the ISL uses an edge control protocol (ECP) transport mechanism.

13. The program of claim 12, wherein information comprises an IGMP group address, a virtual local area network (vLAN) identification and a trunk identification for the IGMP querier.

14. A method, comprising:
receiving an Internet Group Management Protocol (IGMP) leave message by a first switch having a first timer;
transmitting, by the first switch, a synchronization message to a second switch;
updating, by the second switch, a second timer based on receiving the synchronization message, wherein the first timer and the second timer are synchronized.

15. The method of claim 14, wherein the first switch is enabled as an IGMP querier.

16. The method of claim 15, wherein the IGMP leave message is transmitted by a first access switch.

17. The method of claim 16, wherein the synchronization message is transmitted over an inter-switch link (ISL).

18. The method of claim 17, wherein the ISL uses an edge control protocol (ECP) transport mechanism.

19. The method of claim 18, wherein information comprises an IGMP group address, a virtual local area network (vLAN) identification and a trunk identification for the IGMP querier.

20. The method of claim 19, wherein the first switch and the second switch form a first virtual link aggregation group (vLAG) with the first access switch and form a second vLAG with a second access switch.
